(19) United States
(12) Patent Application Publication
(10) Pub. No.: US 2015/0319823 A1
(43) Pub. Date: Nov. 5, 2015

(54) Device for forming a light source

(71) Applicant: Jonathan Stephen Farringdon, Pittsburgh, PA (US)

(72) Inventor: Jonathan Stephen Farringdon, Pittsburgh, PA (US)

(21) Appl. No.: 14/696,548

(22) Filed: Apr. 27, 2015

Related U.S. Application Data
(60) Provisional application No. 61/987,026, filed on May 1, 2014.

(51) Int. Cl. H05B 37/02

(52) U.S. Cl. CPC H05B 37/0209; H05B 37/0245

(57) ABSTRACT

A device that creates non-visible visible-spectrum light comprises of a light source and optics elements that result in irradiated visible spectrum light rays with an intensity that is below a threshold for being visible by a normal observer. For a human observer using photopic or mesopic vision, light rays with an intensity below 3 cd/m² and 0.003 cd/m² respectively are not visible. Changes in vision regime used or ambient light, and the addition of irradiated visible light, result in additional visual effects. User and programmable controls can mediate the light source and optics to control the wavelengths and intensities of the light.

### CROSS-REFERENCE TO RELATED APPLICATIONS

This application claims the benefit of U.S. provisional application No. 61/987,026, entitled “device for forming a light source” filed on 1 May 2014, the entire contents and substance of which are hereby incorporated in total by reference.

### BACKGROUND OF THE INVENTION

1. Field of the Invention

The present invention is in the technical field of lighting. More particularly, the present invention is in the technical field of creating a source of invisible light. More particularly, the present invention is in the technical field of creating a source of sometimes invisible light in the visible light spectrum. More particularly, the present invention is in the technical field of creating a source of invisible and visible light in the visible light spectrum.

2. Description of the Related Art

The human eye sees visible light. The eye has varying sensitivity to different colors of light. Specifically there are components in the eye called “cones” that are differently sensitive to red, green and blue light. Schubert describes the “eye sensitivity function” in terms of light color (wavelength), with the eye being increasingly sensitive to violet (around 400 to 450 nm wavelength), blue (around 475 nm wavelength), cyan (around 500 nm wavelength), then maximally sensitive to green (around 520 to 570 nm wavelength). After green the eye is decreasingly sensitive to yellow (around 570 to 600 nm wavelength), orange (around 600 to 620 nm wavelength), and red light (620 to 750 nm wavelength). This makes up the visible spectrum of light for humans (“Light Emitting Diodes”, Second edition, by E. F. Schubert. Cambridge University Press, 2006).

The approximate vision range for humans is described by Schubert in terms of {no moon, moonlight, twilight, store or office, and sunny outdoors}. At night in low ambient light humans use “Scotopic vision”, with luminance levels from 1E-6 to <0.003 cd/m², “the sense of color is essentially lost in the scotopic vision regime”. In moonlight to twilight humans use “Mesopic vision”, with luminance levels from 0.003 to 3 cd/m². In high ambient light humans use “photopic vision”, with luminance levels from 3 to 1E6cd/m² (“Light Emitting Diodes”, Second edition, by E. F. Schubert. Cambridge University Press, 2006). From short wavelength, and increasing in wavelength, the light spectrum can be described as invisible [Gamma Rays, X Rays, & Ultraviolet Rays], then the visible spectrum, followed by invisible [Infra Red, Microwaves, FA and AM radio waves, & Long Radio Waves].

There are devices that use light where the light is not intended to be seen by humans, and for this purpose the devices use light correspondingly in the non visible spectrum such as infrared light. Infrared light is often used for television remote control units, and for “invisible” security lighting that can not be seen by humans but can be sensed by specially tuned cameras. One popular source for this light is the infrared LED (U.S. Pat. No. 3,293,513 A, Aug. 8, 1962, James R Biard & Gary E Pittman), a 940 nm wavelength LED is typical in current use. There are uses of non visible light where light is intended to be seen at some place away from the light source. There are infrared lasers for creating visible plasma away from the light source (U.S. Pat. No. 7,776,485, Aug. 3, 2010, Momiuchi et al). One shortcoming of such systems is that to transform from invisible light outside of the visible spectrum to visible plasma the system creates a phase change of the medium in which the light is traveling in, with visible light at the place of the phase change. One common use of non visible light that is intended to be seen is in the use of ultra violet light, sometimes referred to as black light. Ultra violet light sources are often used as a lighting effect whereby the ultra violet light itself is not visible to human observers, but the light becomes visible on some clothing, particularly light colored clothing that has been washed with laundry detergents that contain optical brighteners. Common optical brighteners absorb ultraviolet light (around 340 to 370 nm wavelength) and re-emit blue light (around 420 to 470 nm wavelength). One shortcoming of such systems is that the invisible light is outside the visible spectrum and results in visible light through a phase change caused by the materials struck by the light. All these examples use light that is outside of the human visible light spectrum in order to use light that is not seen by human observers.

Light bulbs from the incandescing type (223,898, Jan. 27, 1880, T A Edison) to the recent LED type (U.S. Pat. No. 8,439,528, May 14, 2013, R J Lenk et al) create visible light. Many do so with sufficient brightness to illuminate rooms, they may be safely handled and maintained by homeowners, and they convert energy into light with increasing efficiency as technologies develop. Such light sources are commonly specified in terms of their high brightness compared to their low energy use. Bright light is a shortcoming when invisible lighting is desired.

Micro LEDs can have widths of under 1000 um and thicknesses of under 50 um. For example InGaN micro LEDs are manufactured specifically to emit in the visible spectrum wavelength range of 400 nm to 800 nm, and a good understanding is demonstrated of the electrical power and material requirements to make visible LEDs (20120320581, May 15, 2012, John A Rogers et al). Bright and visible micro LEDs are being made and used in practice with widths of approximately 110 um (Hoon-sik Kim, John Rogers, et al. 2011. Proceedings of the National Academy of Sciences of the United States of America, PNAS vol. 108 no. 25, pp 10072-10077).

Lasers (U.S. Pat. No. 8,104,894, Jan. 31, 2012, K Mori et al) can create visible light that can be shone in beams to illuminate and to present visible images and data. A laser beam can be shone at a target surface such as a wall creating a spot or pattern of light on the target surface. With the usual amount of dust and particles in normal air, in the absence of bright light such as sunlight, a laser beam can sometimes be seen as a straight line of light from the laser source to an object, at least that is the perception to a human observer. Bright light is a shortcoming when invisible lighting is desired. In some settings such as a night club or live music concert the visible scanning beams of a laser are used as a lighting effect and are intended to be seen.

Using, scanning, and focusing light and lasers is well understood and found in everyday items such as flash lights, key fobs, television screens, video projectors, cinema projectors, pen-light lasers, domestic light bulbs, and night club lighting including scanning pattern generating lasers. Non-visible light is also similarly used, for example in television remote controls and the infra-red light sources in devices to position light in air (U.S. Pat. No. 7,776,485, Aug. 3, 2010, Momiuchi et al).

Research and innovation for lighting is performed in terms of reducing power requirements, and increasing efficiency, brightness, lifespan, and color choice. General Electric Lighting offer this comparison for a domestic light bulb: a traditional 60 Watt incandescent bulb uses 60 Watts of power and provides about 800 lumens of luminous flux, the total amount of visible light, and has a lifespan of about 1.1 years. Modern energy efficient alternatives include a halogen bulb using 43W at 750 lm (28% less energy use), a compact florescent lamp (CFL) with halogen using 15W at 800 lm with an 8 year lifespan (75% less energy use), a spiral CLF using 13W at 825 lm and an 8 year lifespan (75% less energy use), and light emitting diode bulbs (LED) using 13W at 800 lm with a 22 year lifespan (75% less energy use) (gelighting.com, replacement bulb comparison charts, April 2015). In all these cases visible light is a primary purpose of the light source.

A system exists for drawing two-dimensional and three-dimensional visible images using scanned and focused non-visible laser light tuned to illicit plasma from the air by means of a phase change. The plasma is visible while the laser light is not in the visible spectrum and this creates a visible flash of light positioned in space (U.S. Pat. No. 7,776,485, Aug. 3, 2010, Momiuchi et al; U.S. Pat. No. 7,533,995, May 19, 2009, Momiuchi et al). The laser light can be made invisible to a human observer by being in the infra-red color spectrum for example, a color that is not visible to a human observer. One shortcoming of such a system is that lasers with power capable of creating plasma from air pose inherent safety risks for nearby observers. One shortcoming of such a system is that laser light in the non-visible spectrum is invisible and an observer does not immediately know when non-visible spectrum light is shining in their eyes, the effect of which may be harmful. When visible light shines in an observers eye there is commonly a blink-response, as well as head movement aversion to the shining light, this can be a healthy response because even low power lasers classified for domestic use can be harmful to eyes. (“Laser Bio Effects”, EHS Radiation Protection Group, Lawrence Berkeley National Laboratory, US Department of Energy, updated Feb. 12, 2015)

Common existing devices that use non visible light operate by employing light that is outside of the human visible light spectrum, such as ultraviolet and infrared light. Common advances in visible light sources relate to the size of the light bulb, the color of the light, and the increased brightness in relation to the reduced power requirements. There are non-visible light sources outside of the visible spectrum, and there are visible-spectrum light sources. Due to the nature of the materials used there are light sources designed to be visible that also emit some non visible light, and vice versa. There are no light sources specifically designed to be non-visible visible-spectrum lights, the very description of such a light appears to be an oxymoron.

### BRIEF SUMMARY OF THE INVENTION

The nature of the present invention relates generally to a method and apparatus for emitting non-visible light beams that are in the visible-light spectrum. More specifically, the present invention is a method and device for forming light that is in an observer's visible-light spectrum but is non-visible to the observer because the intensity of the light is below a threshold for being sensed. Typically the observer could be a person, however the invention can be applied to animal observers and to devices that observe such as cameras, light sensors, and light sensitive chemicals. The device solves the problem of creating light that is both in the observer's visible spectrum, and can not be immediately seen or always seen.

Briefly described, the invention comprises of a device that operates by creating rays of light that are in the visible spectrum with an intensity that is below one of the visible-intensity thresholds for a normal observer. The intensity level at which visible-spectrum light can not be seen changes with the ambient light level and the vision regime used by an observer, and to a small degree varies naturally between observers. What non visible light means in the context of this invention is light rays that have an intensity that is below a threshold for being seen or sensed by an observer, under at least one ambient lighting condition and vision regime used by the observer.

The device operation may include controls and sensors that can calibrate and adjust properties of the emitted light. For some applications, and-or at the user's choice, the device may emit some visible light.

The purpose of the device is to be a class of light-source hitherto unavailable, a non-visible visible-spectrum light bulb. An advantage of the device is that the emitted light is already in the visible spectrum and does not need phase change materials to put (or transfer) the light into the visible spectrum. Another advantage of the device is that emitted light can be non visible when the observer uses one vision regime and visible when the observer uses another vision regime, or when the ambient lighting conditions change. Another advantage of the device is that it emits light at a low power, with the associated safety benefits for nearby observers of low power light.

### BRIEF DESCRIPTION OF THE DRAWINGS

FIG. 1 is a schematic view of a device for emitting light of the present invention;

FIG. 2 is a schematic view of a device for emitting light of the present invention;

### DETAILED DESCRIPTION OF THE INVENTION

The present invention provides a solution to creating an invisible visible-spectrum light source (light bulb), keeping the light at a low power, with the associated safety benefits for nearby observers of low power light, thus being suitable for consumer use and home use as well as professional, scientific, military, and other uses.

The present invention combines an understanding of the physics properties of light, the physical, scientific, and technical properties of components that comprise of the device, together with the physiological and biological responses of the human eye and human visual perception.

The terms invisible and non visible are used interchangeably here, following Mirriam Webster's definition “invisible: not visible, . . . imperceptible”. Some alternate meanings using immutable adjectives such as “impossible to see” or be sensed are not appropriate here. Light intensity is described in SI units of candela per square meter, cd/m². Domestic light bulbs are typically described in SI units of lumen, lm 1 cd/m²=1 lm/m²·sr (sr=steradians). A light source that uniformly radiates one candela in all directions has a total luminous flux of 1 cd·4π sr≈12.6 lm.

The light experienced in everyday life is visible spectrum light. We expect to see visible spectrum light, and it is somewhat counter intuitive that there is visible-spectrum light that is not-visible. The color of light is determined by the frequency. The visibility of light is determined by the frequency and by the intensity. For each vision regime used, the eye can only perceive rays of light that have sufficient intensity above some visibility threshold. Light below the visible-intensity threshold cannot be seen, even when the light may be in the visible spectrum and has a wavelength of visible light. For example, when an observer is using photopic vision and the ambient light intensity is over 3 cd/m², light rays with an intensity of less than 3 cd/m² are not visible. While the observer is using mesopic vision and the ambient light intensity is over 0.003 cd/m² and less than 3 cd/m², light rays with an intensity less than 0.003 cd/m²are not visible. While the observer is using scotopic vision and the ambient light intensity is over 1E-6 cd/m² and less than 0.003 cd/m², light rays with an intensity less than 1E-6 cd/m² are not visible. Because all observers are not identical, the intensity threshold values of non visible light are not exactly the same for all observers and are better described by a Normal statistical distribution reflecting the normal variation between individuals.

The visible spectrum of light for humans has a wavelength of around 380 to 740 nm. For each vision regime, the human eye has different visible-intensity thresholds for different colors. Different human observers will have slightly different visible-intensity thresholds. For a group of random adult observers with fully developed eye sight, for each vision regime there will be a visible-intensity threshold for a specific color (frequency) whereby 65% of the observers can-not see the light if the intensity is below this value, this is the 65%-visible-intensity-threshold-for-frequency-f. There will be a lower intensity threshold whereby 95% of the observers can-not see the light if the intensity is below this 95% -visible-intensity-threshold-for-frequency-f. By varying the intensity of the visible wavelength light is it possible to set the intensity so that all human observers with normal healthy eyesight can see the light, down through 65% not being able to see it, down to 95%, down to 99% of observers not being able to perceive the light, and so forth to a point where all observers with normal vision can not see the light beams because the light beams have an intensity below the visible-intensity threshold of the observers. Some light sensors, cameras, and animals may detect the presence of a low intensity light when a human observer does not.

What non visible light means in the context of this invention is light rays that have an intensity that is below an intensity threshold for being seen or sensed by an observer, under at least one ambient lighting conditions or vision regime used by the observer. There can be instantiations of the invention that emit light that is non visible by an observer for one combination of ambient lighting conditions and vision regime, and the same light intensity emitted from the same device may be sensed by the same observer under different ambient lighting conditions using a different vision regime. For example if the emitted light has an intensity of 2 cd/m² and the ambient light is just above 3 cd/m² and the observer is using photopic vision then the emitted light is not visible, and if the ambient light is just above 0.003 cd/m² and the same observer is using mesopic vision then the same light intensity is visible. Thus the invention emits non visible light under certain lighting conditions and vision regimes.

For convenience the human observer is frequently referred to, while the invention is not limited to human observers. When the intended observers are human the visible spectrum has a range of about 380 to 740 nm. When the intended observers are animals use the visible light spectrum and visible-intensity thresholds of those animals. Some insects and birds for example can see light in the ultraviolet spectrum of 300 to 400 nm. When the intended observers are light sensors such as cameras then use the visible light spectrum and visible-intensity thresholds of the light sensor. Thus the visual effects of the invention that a human can see first-hand can be similarly portrayed in a photograph or film recording.

While it is possible to construct an embodiment of this invention without programmable or software-executing components, like many modern electronics devices this invention could contain programmable components. Being programmable bestows advantages such as construction using common electronics components, updating software in order to fix problems, and updating software to improve and increase product operation and features.

The present invention emits light that is in the human visible spectrum with an intensity that is not visible by the human observer. Visible light may also be present. The amount of visible light is dependent upon factors including the capabilities of the device, the inputs to the device, and operator choice.

In a first aspect of the invention, a non visible light formation device is disclosed that comprises of a light source and optics system that emits visible spectrum light with a low intensity such that the light is not visible by a normal observer. The addition of visible light results in additional visual effects. For a human observer the emitted light may be below one of three visible intensity thresholds, 3 cd/m² for photopic vision, 0.003 cd/m² for mesopic vision, and 1E-6 cd/m² for scotopic vision. The invention uses the combination of the observer's light sensitive physiology and the physics of light to create for the observer the oxymoron of non-visible visible-spectrum light.

In the first aspect the light source may emit an overly significant amount of visible-intensity light, and the light rays inside the device travel through materials with optical properties such that there are light rays emitted from the device at an intensity that is below a threshold to be sensed by an observer. One example is an LED where the LED's housing reduces the emitted light intensity. Another example is a laser with the laser's filter components reducing the emitted light intensity.

In the first aspect there may be a plurality of internal and user controls operative to adjust aspects of the light source and the optics system such that the controls are structured to adjust the intensity and frequency of the rays of light. With the introduction of control, the device can be used in more technically and artistically sophisticated ways.

In a second aspect of the invention, the light source and or the optics system are operative to generate multiple and or adjustable frequencies of light; and sub light sources can act as a compound light source. Further, the optics system comprises of at least one of: a combination of lenses, filters, diffraction patterns, scanning mechanisms, mirrors, micro-machines, and DLP micro mirror projectors. The optics may be capable of reducing the intensity of visible light so that is it not visible. For example in a lit room, a 5 mW 650 nm wavelength red class IIIa laser may have its beam intensity reduced using a sequence of 5 neutral density filters of density rating 2 (1F-stop, 50% transmittance), 8 (3F-stops, 12.6% transmittance), 8, 8, and 2. Still further, the optics system comprises of at least one of: a plurality of analog components; a plurality of digital components. Suitable light sources include one or more light bulbs, light emitting diodes (LEDs), lasers, electroluminescent material, and the display of a computing device, as well as macro and micro manufactured versions of each. Light sources such as flames and plasma are possible to use; while perhaps less practical such light sources may be desirable if making the device in the steam-punk genre.

In the second aspect, a data communication section of the control may be operative to allow the control system to communicate with other devices connected through at least one of a wired connection or a wireless connection, using data protocols including internet protocols and standards such as Wi-Fi (Wi-Fi Alliance, Austin, USA). The other devices may include other lighting devices, sensors, and remote control devices such as applications running on smart phones. The device may also include sensors. The sensors may comprise of at least one of: digital, analogue, light, radiation, and electromagnetic. Further, the sensors may be structured for remote sensing and wireless sensing. The sensors may be used to calibrate the emitted light.

In the second aspect, the controller may be a general computing device, and may have a programmable component. The control system may be a computing device that can operate independently of the device, such as a programmable smart-phone, tablet computer, or computer.

In the second aspect, the visible and non-visible light intensities are tuned for the observer, who may be a child or an adult human, or may be an animal, or a light sensor such as in a camera.

In a third aspect of the invention the light source may emit a significant amount of non-visible visible-spectrum light, because the light source components and energy supply have been tuned specifically to emit light at intensities below a threshold for being sensed by observers.

In the third aspect, the light rays inside the device may travel through materials with optical properties such that light rays emitted from the device are at an intensity that is below a threshold that can be sensed by an observer. One example is an LED with components to reduce the operational power. Another example is a laser with components to reduce the operational power.

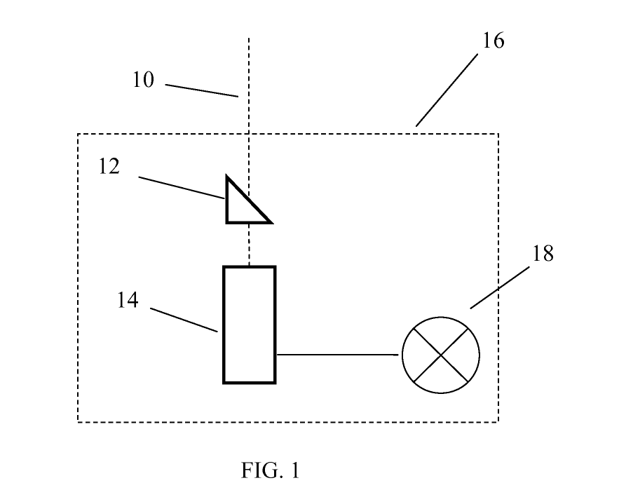

Referring now to the invention shown in FIG. 1 there is shown a device for creating light 16, having multiple rays of non visible light 10. The lighting device 16 consists of optics 12, a light source 14, and controls 18.

In more detail, still referring to the invention of FIG. 1 the non visible rays of light 10 are in the visible spectrum at an intensity that is below a threshold for being sensed by a normal observer under some combination of ambient lighting condition and vision regime. The light source 14 creates light which may be at a non visible intensity and-or at a visible intensity. There are light rays 10 leaving the device 16 with an intensity below a visible-intensity threshold. The light rays 10 may include some visible light, this may be achieved by properties of the optics 12 that allow visible light to pass, or by the light source 14 producing a light intensity that passes through the optics 12 and housing materials 16, and-or by the controller 18 controlling the output of the light source 14 or the optics 12, to result in light rays 10 containing both visible-light and non-visible light. User or automated or fixed controls 18 can set or adjust aspects of the light source 14 and optics 12, for example adjust the intensity of specific colors of the light rays 10. The light source 14 and optics 12 may generate multiple colors of light by the mediation of the light source 14 for example by the controls 18 adjusting the frequency or adjusting the combination of sub light sources in a compound light source, and-or by adjusting the optics 12, for example by using filters. The controller 18 may be minimal, for example a wire controlling the supply of energy to the light source 14 without undue modification, or controlling the energy to the light source 14 by modifying aspects of the energy en route to the light source 14.

In further detail, still referring to the invention of FIG. 1 a convenient light source 14 may be one or more lasers which are available encased at sizes less than 5 cm³, or pulse lasers with a pulse width of say 50 ns or less, or LEDs that may have a size of less than 5 mm³, or micro LEDs that may have a size of less than 605 um³. The optics 12 mediate aspects of path, focus, intensity, and other optical properties of the light. These may be combinations of lenses and filters or other optical transfer and mediation components. When the light source 14 emits an overtly significant amount of visible light then the optics 12 and the device housing 16 may mediate the light so that there are light rays 10 with an intensity below a visible-intensity threshold. When the light source is powered by electricity, convenient controls 18 are wires that take supplied electrical power and modify the expected, sometimes specified, power using power mediation components and support components as necessary, such that the power available to the light source 14 results in light rays 10 that are non visible because of their low intensity. A more sophisticated control 18 includes the ability to change the power mediation, for example at one setting some light rays 10 have an intensity of less than the visible intensity threshold of 3 cd/m², and at another setting some light rays 10 have an intensity of less than the visible intensity threshold of 0.003 cd/m².

The construction details of the invention as shown in FIG. 1 are that the light source 14 is made from LEDs or lasers or other lighting device materials such as micro LEDs, electro luminescent materials, or other light bulbs, and the optics 12 can be any suitable optics components and materials such as glass, plastics, coatings, diffraction patterns, or mirrored material or micro machines or integrated materials for mediating the light emitted by the light source 14 and resulting in rays of light 10 that have an intensity that is below a threshold for being visible by an observer. The control 18 may be able through analogue or digital components to mediate the energy supply to the light source 14 such as mediating the voltage, amperage, polarization, or frequency. One construction of the invention as shown in FIG. 1 is analogous to starting with a largely visible light source 14 and mediating it, for example by modifying the housing materials to effect filters 12 so that non visible light 10 is emitted. Another construction of the invention as shown in FIG. 1 is analogous to starting with a largely visible light source or technology and mediating it, say with control components 18 that modify the input power, for example in terms of voltage, amperage, polarization, or frequency, such that the light source 14 produces non visible light 10 with an intensity that is below a visible-intensity threshold. Another construction of the invention as shown in FIG. 1 is analogous to starting with a largely visible light source or technology and mediating it, say by modifying the housing materials to effect filters 12 and with control components 18 that modify the input power, for example in terms of voltage or amperage or frequency, such that the light source 14 produces non visible light 10 with an intensity that is below a visible-intensity threshold.

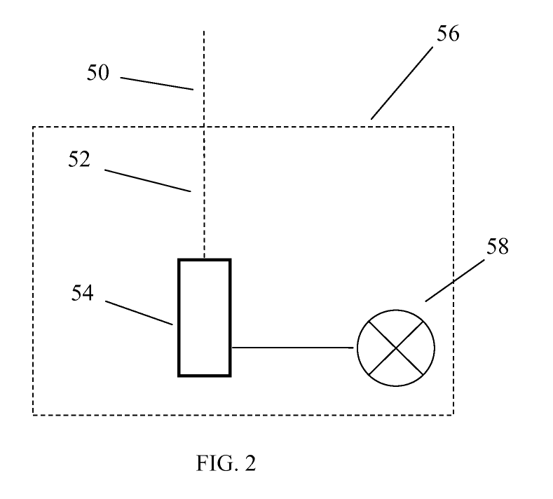

Referring now to the invention shown in FIG. 2 there is shown a device for creating light 56, having multiple rays of non visible light 50. The lighting device 56 consists of a light source 54, and controls 58.

In more detail, still referring to the invention of FIG. 2 the non visible rays of light 50 are in the visible spectrum at an intensity that is below a threshold for being sensed by a normal observer under some combination of ambient lighting condition and vision regime. The light source 54 creates light 52 which may be at a non visible intensity and- or at a visible intensity. There are light rays 50 leaving the device 56 with an intensity that is below a visible-intensity threshold. The light rays 50 may include some visible light, this may be achieved by properties of the light source 54 producing a light intensity that passes through the device housing materials 56, and-or by the controller 58 controlling the output of the light source 54 to result in light rays 50 containing both visible light and non visible light. User or automated or fixed controls 58 can be in place to adjust aspects of the light source 54, for example adjust the intensity of specific colors of the light rays 50. The light source 54 may generate multiple colors of light by the mediation of the light source 54 for example by the controls 58 adjusting the frequency or adjusting the combination of sub light sources in a compound light source. The controller 58 may be minimal, for example a wire controlling the supply of energy to the light source 54 without undue modification, or controlling the energy to the light source 54 by modifying aspects of the energy en route to the light source 54.

In further detail, still referring to the invention of FIG. 2 a convenient light source 54 may be one or more lasers which are available encased at sizes less than 5 cm³, or pulse lasers with a pulse width of say 50 ns or less, or LEDs that may have a size of less than 5 mm³, or micro LEDs that may have a size of less than 605 um³. The housing of the device 56 may mediate aspects of path, focus, intensity, and other optical properties of the light. These may be combinations of lenses and filters and coatings or other optical transfer and mediation components. When the light source 14 emits an overly significant amount of visible light then the device housing 56 may mediate the light traveling through the housing materials 52 so that there are light rays 50 at an intensity below a threshold to be visible. When the light source is powered by electricity, convenient controls 58 are wires that take supplied electrical power and modify the expected power using power mediation components and support components as necessary, such that the power available to the light source 54 results in light rays 50 that have an intensity below a visible-intensity threshold. A more sophisticated control 58 includes the ability to change the power mediation, for example at one setting some light rays 50 have an intensity of less than the visible-intensity threshold of 3 cd/m², and at another setting some light rays 50 have an intensity of less than the visible-intensity threshold of 0.003 cd/m².

The construction details of the invention as shown in FIG. 2 are such that the entire device 56 may be described as a light source such as a light bulb, laser, LED, and so forth. In the schematic representation the light source 54 is the component part of the device 56 where light emanates. The light 52 passes through the device housing component materials such as gas and glass of a light bulb, colored and clear and patterned lenses and diffraction patterns of a laser, and filtered, colored and clear plastics and glass of an LED. Invisible light rays 50 are emitted with an intensity below a visible-intensity threshold. The control 58 may be able through analogue or digital components to mediate the energy supply to the light source 54, such as mediating the voltage, amperage, polarization or frequency of pulse. One construction of the invention as shown in FIG. 2 is analogous to creating a light bulb, laser or LED bulb, or other light, that takes the standard power inputs to the device 56, common examples being one of 240 Volts, 110V, 5V, 3V or 1.5V, and controlling the power with control components 58 such that the light source 54 emits light 50 in the visible spectrum at an intensity that is below a visible-intensity threshold. For example a light source similar to a 650 nm wavelength red class IIIa laser, with a controlled power supply with laser generation operating at 0.0025 mW, emitting light 50 under the visible-intensity threshold of 3 cd/m² that is non visible to a normal human observer using photopic vision in a lit room. Another construction of the invention as shown in FIG. 2 is analogous to creating a light bulb, laser or LED bulb, or other light, that emits light in the visible spectrum at an intensity that is not visible 50 by means of the casing materials of the device 56 filtering the light 52 that is produced by the light source 54, resulting in non visible light 50 being emitted. For example if the light source were similar in light intensity to a 5 mW 650 nm wavelength red class IIIa laser, with a housing material that acted as a neutral density filter with a 0.05% transmittance, then the emitted light 50 would be under the visible-intensity threshold of 3 cd/m² and non visible to a normal human observer using photopic vision in a lit room. Another construction of the invention as shown in FIG. 2 is analogous to creating a light bulb, laser or LED bulb, or other light, that emits light in the visible spectrum at an intensity that is not visible 50 by means of controlling the input energy specification, such than when external energy is supplied that meets the controlled specification the light 52 that is produced by the light source 54 results in non visible light 50 being emitted with an intensity below a visible-intensity threshold.

The advantages of the present invention include, without limitation, the ability to create visible spectrum light that is not visible to the human observer under some conditions of ambient light and vision regime used, and sometimes be visible under different conditions of ambient light and vision regime used. Further, aspects of the light such as color and intensity can be set at manufacture and optionally controlled in use. Further, the device can be constructed to operate using relatively little power compared to a traditional visible spectrum light source, and the emitted low intensity light is safer for nearby observers compared to relatively high powered non-visible light generating devices. Further, if the light from the device was unintentionally or intentionally at a high power then the emitted light may be visible and observers nearby would have a natural blink and aversion response to seeing the light which can act as a natural safety mechanism for an observer.

In broad embodiment, the present invention is a device that creates visible-spectrum light that is not visible to an observer, under some conditions of ambient light and vision regime used, because the light intensity is below a visible-intensity threshold.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. A device for forming light comprising of:
a light source,
and irradiated light rays,
where the light source creates light rays, and the irradiated light rays are in the visible spectrum and at an intensity that is below one of the thresholds for being visible to an observer.

2. A device of claim 1, further comprising of at least one of:
an optics system,
and a control system.

3. A device of claim 1, wherein the light source comprises of at least one of:
a light bulb,
a light emitting diode,
a laser,
electroluminescent material,
the display of a computing device,
a flame,
and plasma.

4. A device of claim 1, further comprising of visible irradiated light rays.

5. A device of claim 1, wherein some of the irradiated light rays have an intensity <=3 cd/m² and or <=0.003 cd/m² and or <=1E-6 cd/m².

6. A device of claim 1, wherein the visual spectrum and the intensity thresholds for being visible correspond to at least one of these observer types:
a human child,
a human adult,
an animal,
and a camera.

7. A device of claim 2, wherein the optics system comprises of at least one of:
an optically neutral component,
a housing for the light source,
a filter,
a diffraction pattern,
a beam splitter,
a micro-machine,
an analogue component,
and a digital component.

8. A device of claim 2, wherein the control system comprises of at least one of:
a conductor,
an electronic component, active, passive, or electromechanical,
an internal control component,
and a user adjustable control,
operative to adjust aspects of the light source and or the optics system.

9. A device of claim 2, wherein the control system mediates the input power to a power-specification at which the light source irradiates light at an intensity below a threshold for being sensed by an observer.

10. A device of claim 2, wherein the control system has a programmable component.

11. A device of claim 2, wherein the control system includes sensors and or outputs.

12. A device of claim 2 wherein the control system includes a data communication system that can do at least one of:
communicate over wire,
communicate wirelessly,
communicate with sub components of the device,
communicate with other devices,
communicate with a separate remote control system,
and communicate over the Internet.

13. A device of claim 2 wherein the control system effects the light source to produce light at multiple frequencies.

14. The device of claim 11 wherein the control system is operative to calibrate or adjust at least one of: the light source, the optics system, and the irritated light.

15. The device of claim 12 wherein the control system is operative to communicate with other lighting controls or remote controls.

16. The device of claim 11, wherein the sensors comprise of at least one of:
a digital sensor,
an analogue sensor,
an integrated sensor,
a remote sensor,
a light sensor,
an electromagnetic sensor,
and a radiation sensor.
